(19) United States
(12) Patent Application Publication
(10) Pub. No.: US 2002/0167308 A1
(43) Pub. Date: Nov. 14, 2002

(54) Miniaturized positional assembly and method of manufacturing

(76) Inventor: Larry L. Davis, Milwaukie, OR (US)

Correspondence Address: TIMOTHY E SIEGEL, 1868 KNAPPS ALLEY, SUITE 206, WEST LINN, OR, 97068, US

(21) Appl. No.: 09/851,704

(22) Filed: May 8, 2001

(51) Int. Cl. G01B 7/14

(52) U.S. Cl. 324/207.15; 324/220

(57) ABSTRACT

A method of producing a miniaturized set of orthogonal inductive coils set inside a tube. The method includes providing a platform, attaching the coils to the platform and providing a tube, encompassing the coils.

### BACKGROUND OF THE INVENTION

The ability to accurately determine the position of a device within the body currently yields a considerable benefit for at least one medical procedure. This is the electrophysiological mapping of the heart. Such mapping frequently permits the location and treatment of the neurological disorder that has given rise to a heart arrhythmia. In order to accurately perform this mapping a transceiver head must be introduced into the heart by way (in part) of the femoral artery. The position and orientation of this transceiver head must be accurately monitored.

In order to perform this monitoring a set of orthogonally positioned inductive coils are fixed at the transceiver head and conductively connected through the catheter to the outside of the body, where the current in each of the inductive coils can be read. Cooperating with these coils, powerful magnets are arrayed about the imaging station, so that the current through each coil is dependent on its orientation relative to the magnetic field created.

Heretofore, the manufacture of the unit in which the coils reside has been a challenging and expensive operation. Each coil was soldered to a pair of wires and adjusted so that its position was generally correct. Next the coils and attached wires are gently placed into a polymer tube, which is then filled with epoxy to retain the coils in their generally mutual orthogonal positions and to retain the tube in its protective position.

Performing this method resulted in many problems. First, there was the difficulty in maintaining the mutually orthogonal orientation of the inductive coils during their insertion into the tube and the filling of the tube with epoxy. Also, air pockets would sometimes form as the epoxy was being introduced into the tube.

### SUMMARY

In a first separate aspect, the present invention is a method of producing a miniaturized set of orthogonal inductive coils set inside a tube. The method includes providing a platform, attaching the coils to the platform and providing a tube, encompassing the coils.

In a second separate aspect, the present invention is a miniaturized navigational aid, comprising a set of substantially orthogonal inductive coils. A tube, which includes a single circumferential wall, which in turn, defines at least one aperture, is set about the inductive coils. Adhesive material fills the tube, thereby fixing in place the set of substantially orthogonal inductive coils and wherein a portion of the adhesive material extends into the aperture(s) to securely anchor the tube.

In a third separate aspect the present invention is a miniaturized navigational device, comprising a set of orthogonal inductive coils and a tube encompassing the inductive coils. The tube is made of a flexible sheet having a first edge and a second edge and being rolled up so that the first edge abuts the second edge.

The foregoing and other objectives, features and advantages of the invention will be more readily understood upon consideration of the following detailed description of the invention, taken in conjunction with the accompanying drawings.

### BRIEF DESCRIPTION OF THE DRAWINGS

FIG. 1 is a plan view of a flex circuit adapted to be used in the method of the present invention.

FIG. 2 is a plan view of a work piece, making use of the flex-circuit of FIG. 1, and constituting a stage in the method of the present invention.

FIG. 3 is a perspective view of the work piece of FIG. 2.

FIG. 4 is a perspective view of a miniaturized inductive navigational device, constructed according to the method of the present invention.

FIG. 5 is a plan view of an alternative flex circuit adapted to be used in the method of the present invention.

FIG. 6 is a plan view of an alternative work piece, making use of the flex-circuit of FIG. 5, and constituting an alternative stage in the method of the present invention.

FIG. 7 is a perspective view of the work piece of FIG. 6.

FIG. 8 is a perspective view of an alternative miniaturized inductive navigational device constructed according to the method of the present invention.

### DETAILED DESCRIPTION OF THE PREFERRED EMBODIMENT

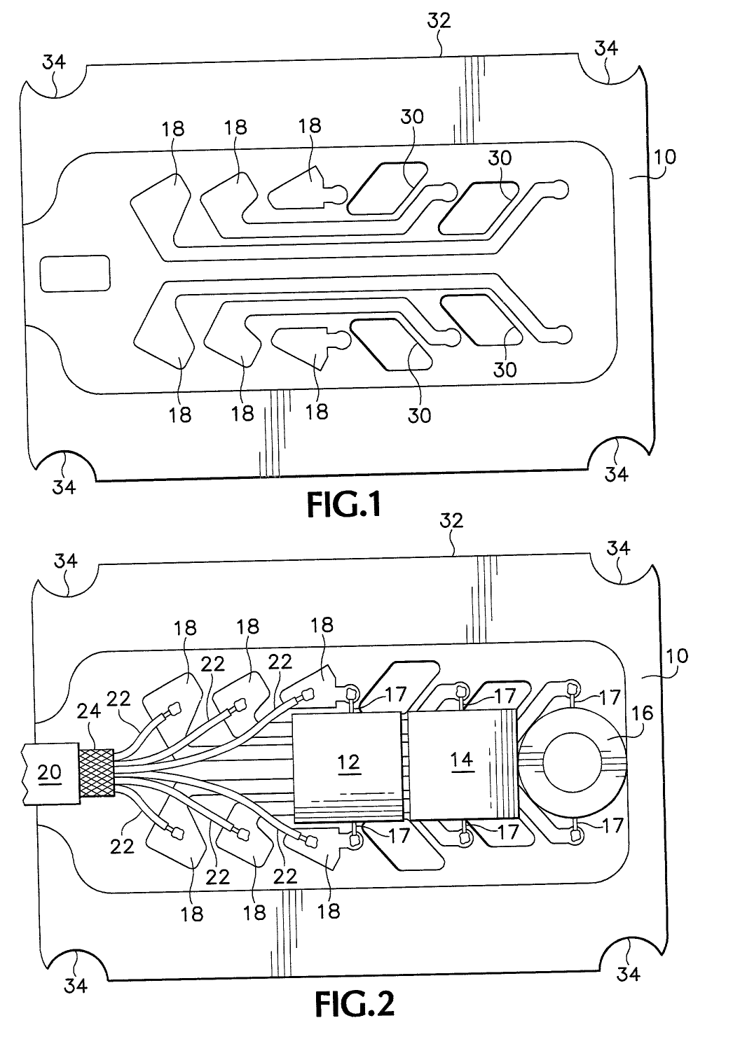

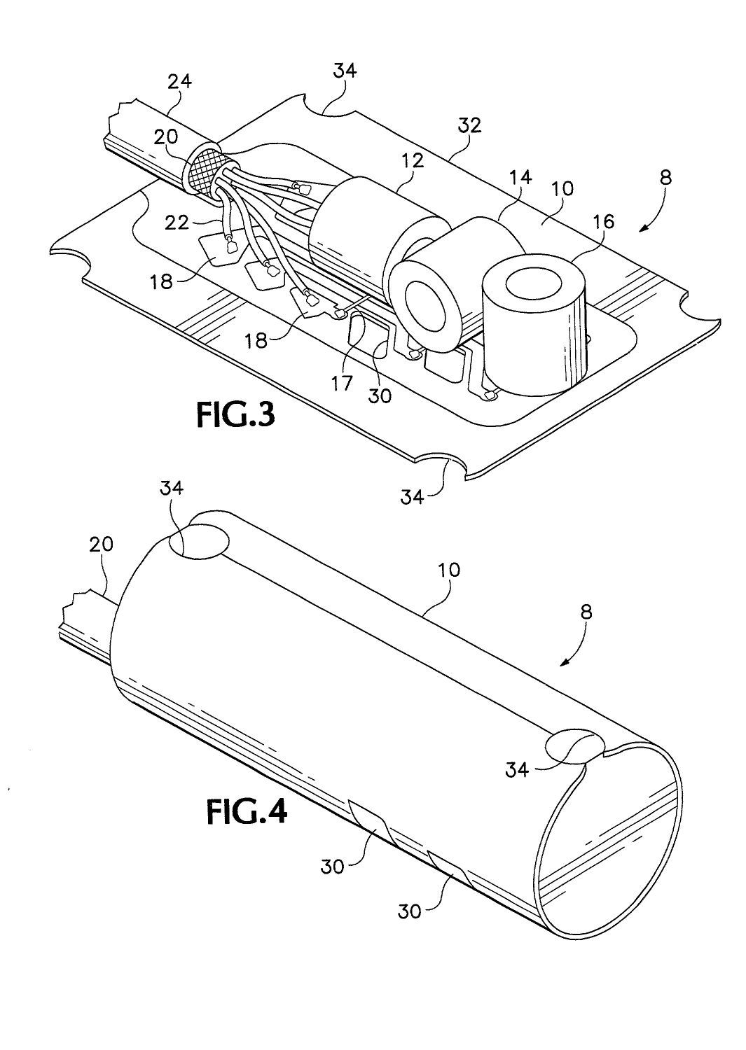

Referring to FIGS. 1-4, in a first preferred embodiment of a method of manufacturing a miniaturized navigational device 8 (FIG. 4), a piece of flex-circuit 10 is provided that is sized to accommodate a set of inductive coils 12, 14 and 16 when rolled into a tube. The flex circuit has a set of six traces 18, each of which extends from an area adapted to a wire coming from the left in the FIGS., to a position adapted to permit the attachment of a terminal 17 of one of the inductive coils 12, 14 and 16.

Each of the three coils 12, 14 and 16 may be placed by a robot onto the flex circuit, which preferably has been readied for each with a drop of epoxy to hold the coil in place during further operations. The termini (not shown) of each coil are then soldered to the appropriate flex circuit trace 18. A cable 20 is composed of a set of six wires 22 and a shield 24. Each wire 22 is soldered to a circuit trace 18. Although more soldering operations are required than would be necessary if wires 22 were directly soldered to the terminals of the inductive coils 12, 14 and 16, the soldering operations are made far more repeatable and therefore may be automated. In addition the shield 24 of cable 20 is soldered to flex circuit 10 to affirmatively anchor flex circuit 10 to cable 20.

After the electrical and physical attachment of the inductive coils 12, 14 and 16 to the flex circuit 10, it is rolled up so that its two side edges 32 precisely abut each other. Epoxy resin is poured in through a first one of two holes created by a set of four scallops 34 that are defined by the flex circuit 10. The second of the two holes created by scallops 34 permits the exit of air, to accommodate the introduced epoxy and avoid the formation of air bubbles. Although both sides of the tube formed by flex circuit 10 are open, it is possible at this point in the manufacturing process that the manufacturing equipment could occlude one or both ends. The amount of epoxy poured onto assembly 10 is chosen to be slightly greater than the amount that can be accommodated by flex circuit 10 and so, as a result, some epoxy oozes through a set of apertures 30, thereby positively anchoring flex circuit 10 to wires 22 and inductive elements 12, 14 and 16.

Moreover, because inductive elements 12, 14 and 16 are positioned and retained on flex circuit 10 prior to being connected to wires 22, the probability that these elements will be truly orthogonal to one another is greatly increased.

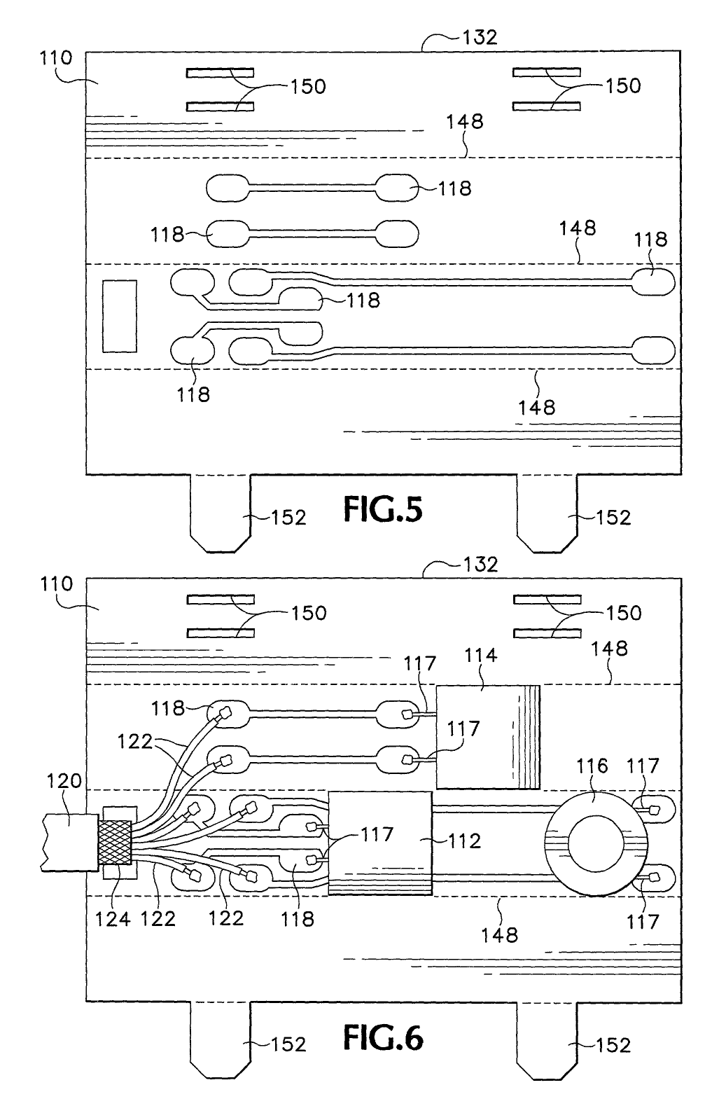

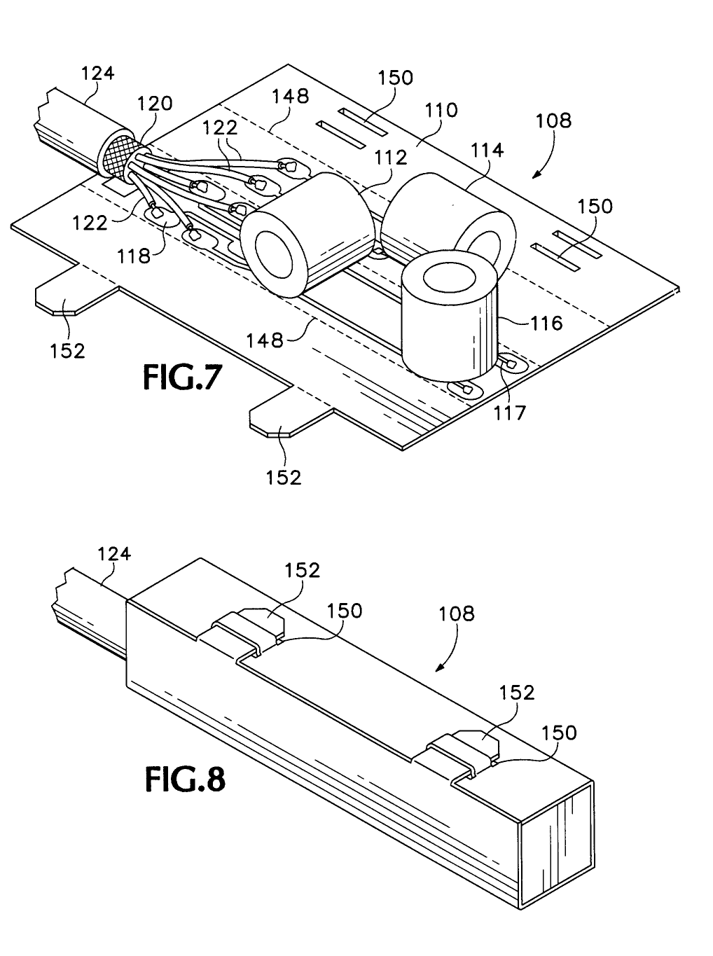

Referring to FIGS. 5-8, in a second preferred embodiment, elements 108, 110, 112, 114, 116, 117, 118, 120, 122, 124 and 132 each performs the same function as the element numbered by the same reference number, minus 100, in the first preferred embodiment. In addition, however, flex circuit 110 is laser scored along score lines 148. A score line 148 separates inductive coils 112 and 116 from inductive coil 114. When flex circuit 110 is folded about the score lines 148, inductive coil 114 is placed in close proximity with coils 112 and 116 and flex circuit 110 forms a square tube. A set of slots 150 accepts a pair of tabs 152 to positively close the square tube. Slots 150 also allow air to leave device 8. Some epoxy resin also seeps into slots 150, thereby positively retaining flex circuit 110.

The terms and expressions which have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims which follow.

1. A method of producing a miniaturized set of inductive coils set mutually orthogonally inside a tube, comprising:
(a) providing a set of inductive coils;
(b) providing a platform;
(c) attaching said coils to a platform; and
(d) providing a tube, encompassing said coils.

2. The method of claim 1 wherein said platform is curled up about said coils to form said tube.

3. The method of claim 1 wherein each inductive coil has two termini and said platform is a piece of flex circuit bearing a set of conductive traces each terminating at a first end positioned to facilitate connection to a said inductive coil terminus and also terminating at a second end located at an edge of said piece of flex circuit in close proximity with other second ends of said traces and further comprising the step of connecting said inductive coils to said trace first termini and providing a multi-wire cable and connecting said wires of said multi-wire cable to said second termini of said traces.

4. The method of claim 1 further comprising the step of fixing said coils inside said tube by adhesive.

5. The method of claim 4 wherein said platform is curled up about said coils to form said tube and in which said adhesive is introduced onto said platform prior to said platform being curled up to form said tube.

6. The method of claim 1, wherein said tube is a round tube.

7. The method of claim 1, wherein said tube is a square tube.

8. A miniaturized navigational aid, comprising:
(a) a set of substantially orthogonal inductive coils;
(b) a tube set about said inductive coils, said tube, said tube defining at least one aperture; and
(c) adhesive material filling said tube, thereby fixing in place said set of substantially orthogonal inductive coils and wherein a portion of said adhesive material extends into said at least one aperture to securely anchor said tube.

9. A miniaturized navigational device, comprising:
(a) a set of orthogonal inductive coils; and
(b) a tube encompassing said inductive coils, said tube made of a flexible sheet having a first edge and a second edge and being rolled up so that said first edge abuts said second edge.
